(19) United States
(12) Patent Application Publication
(10) Pub. No.: US 2026/0171926 A1
(43) Pub. Date: Jun. 18, 2026

(54) Power Supply Circuitry with Fast Current Supply and Cutoff

(71) Applicant: Arista Networks, Inc., Santa Clara, CA (US)

(72) Inventor: Charles Melvin Aden, Berkeley, CA (US)

(21) Appl. No.: 18/982,546

(22) Filed: Dec. 16, 2024

(51) Int. Cl. H02M 7/217; G06F 1/26; H02M 1/36; H02M 1/38

(52) U.S. Cl. CPC H02M 7/217; G06F 1/26; H02M 1/36; H02M 1/38

(57) ABSTRACT

Power supply circuitry can include one or more current source stages. A current source stage can include a current source, a current recirculation transistor that recirculates current provided by the current source via a current recirculation path, and a rectifier configured to operate synchronously with the current recirculation transistor and coupled between the current source and an output of the power supply circuitry.

### BACKGROUND

Electronic components can require power to operate. Power supply circuitry can apply supply voltage(s) to these electronic components and supply current(s) to these electronic components. Different electronic components can have different power requirements, leading to the use of different types of power supply circuitry to power these different electronic components.

### BRIEF DESCRIPTION OF THE DRAWINGS

FIG. 1 is a diagram of illustrative power supply circuitry configured to supply current to one or more electronic components in accordance with some embodiments.

FIG. 2 is a circuit diagram of an illustrative current source stage in accordance with some embodiments.

FIG. 3 is a diagram of illustrative control logic circuitry configured to regulate an output current of a current source in accordance with some embodiments.

FIG. 4 is a diagram of illustrative initial states of a control signal based on the mode of operation for a current source stage in accordance with some embodiments.

FIG. 5 is a diagram of illustrative power supply circuitry containing control logic circuitry configured to control the mode of operation of a current source stage in the power supply circuitry in accordance with some embodiments.

FIG. 6 is a diagram of an illustrative set of current source stages operable to collectively provide an output current in accordance with some embodiments.

FIG. 7 is a diagram of illustrative control logic circuitry configured to control the modes of operation of multiple current source stages in accordance with some embodiments.

### DETAILED DESCRIPTION

Electronic components (e.g., active electronic components) can require power to operate. Power supply circuitry can supply power to these electronic components. To supply power, the power supply circuitry can supply current and apply supply voltages to these electronic components. Some electronic components can require vastly different amounts of current within a relatively short amount of time. For example, to operate in a satisfactory manner, one electronic component may require a current of 400 amperes (A) at a first time and require a current of 1000 A at a second time 300 nanoseconds (ns) later, and/or may require a current of 1000 A at a third time and require a current of 0 A at a fourth time 600 ns later. It can be challenging for typical power supply circuitry to handle the current changes within the short time frame required by these types of electronic components. In particular, typical power supply circuitry (e.g., typical buck converters) include inductance(s) along the current supply path, which can inherently introduce time delays when outputting the energy, thereby limiting the handling of current requirement changes of electronic components within short time frames.

To improve current supply and cutoff performance (e.g., to provide faster current supply and cutoff) for a large range of current requirements, thereby addressing the above-mentioned issues, and/or to impart other advantages, illustrative power supply circuitry is described herein. The power supply circuitry may include a current source having an inductor. The current provided by the inductor may be regulated to achieve a target current value regardless of whether or not the power supply circuitry is supplying an electronic component with power. During a first mode of operation, when the electronic component is supplied with power, the current provided by the inductor may be supplied to the electronic component via a diode (e.g., implemented as an active rectifier that includes a transistor). During a second mode of operation, when the electronic component is not supplied with power, the current provided by the inductor may be recirculated using a current recirculation transistor back to the inductor. The current recirculation transistor and the transistor of the (active) rectifier may be controlled in a synchronous (e.g., coordinated) manner.

The switching between the two modes of operation, and consequently the supply and cutoff of current to the electronic component, relies on the switching of transistors, without (or with minimal) inductive characteristics on the current supply path to the electronic component, thereby improving current supply and cutoff behavior (e.g., quickening current supply and cutoff), among other advantages. Multiple current source stages implemented in this manner may be used in the power supply circuitry to scale the power supply output current to satisfy the range of current requirements of the electronic component.

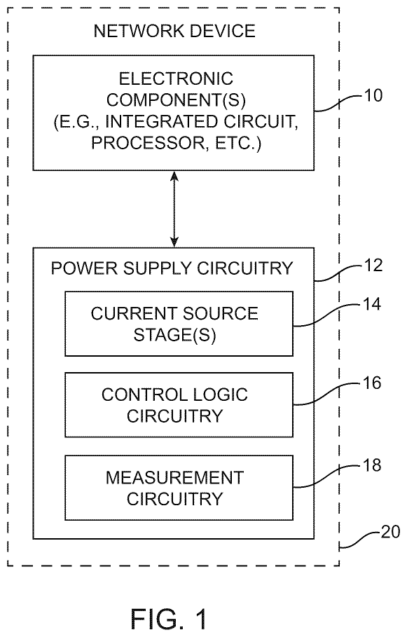

An illustrative system in which power supply circuitry with improved current supply and cutoff behavior (e.g., of the type described above and generally herein) can be employed is shown in FIG. 1. As shown in the example of FIG. 1, a system may include one or more electronic components 10 that are coupled to power supply circuitry 12. Electronic components 10 may be configured to operate at least in part by receiving power from power supply circuitry 12. In particular, power supply circuitry 12 may apply voltages on corresponding voltage supply paths (e.g., voltage supply rails) coupled to electronic component(s) 10 and may supply current on these paths to electronic component(s) 10.

As examples, electronic components 10 may include integrated circuits (e.g., processor integrated circuits, memory integrated circuits, and other types of integrated circuits) and other types of active electronic components configured to operate when power is received (e.g., amplifiers, digital logic circuits, voltage regulators, voltage sources, current sources, light emitting devices, sensors, other circuitry that includes diodes, other circuitry that includes transistors, etc.).

In some illustrative configurations described herein, power supply circuitry 12 may be configured to exhibit enhanced (fast) current supply and cutoff behavior for powering the one or more electronic components 10. Power supply circuitry 12 (sometimes referred to as power management circuitry 12) may be implemented as a single integrated circuit (e.g., as a single integrated circuit die or an integrated circuit die package) or may be implemented across multiple integrated circuits (e.g., include circuitry in multiple integrated circuit dies and/or die packages). As shown in FIG. 1, power supply circuitry 12 may include one or more current source stages 14, control logic circuitry 16 (sometimes referred to as control logic 16 or controller 16), and measurement circuitry 18, among other components.

Each current source stage 14 may supply current (e.g., at least a portion of the total current) output to electronic component 10 during a first mode of operation and may cutoff the supply of current to electronic component 10 during a second mode of operation. Control logic circuitry 16 may provide control signals to the components of current source stage(s) 14 (e.g., transistors therein) to appropriately operate each current source stage 14 to implement and/or operate during the first or second mode of operation and to switch between the first and second modes of operation based on operational data gathered from within power supply circuitry 12 and/or based on operational data obtained from electronic component 10 or other external components (e.g., control circuitry or driver circuitry for component 10). As an example, at least some of these types of operational data may be measurement data obtained from measurement circuitry 18.

Control logic circuitry 16 may include microprocessors, microcontrollers, programmable logic devices such as field programmable gate array (FPGA) devices, application specific system processors (ASSPs), application specific integrated circuit (ASIC) processors, and/or other types of processors, may include logic gates, combinational logic circuits (e.g., arithmetic circuits, comparison circuits or comparators, multiplexing circuits, etc.), sequential logic circuits (e.g., state machines, flip-flops, registers, counters, etc.), and/or may include digital and/or analog circuits for generating control signals based on inputs received over time (e.g., measurement data from measurement circuitry 18 received during operation of circuitry 12 and/or component 10). In some illustrative configurations described herein as an example, control logic circuitry 16 may include a proportional-integral-derivative (PID) controller (e.g., implemented using one or more of the illustrative (hardware) components of control logic circuitry 16 described above).

Measurement circuitry 18 may include sensors such as current sensors, voltage sensors, power sensors, and/or other types of sensors. Measurement circuitry 18 (e.g., one or more of these sensors) may be coupled to (other) internal components within power supply circuitry 12 to gather sensor data (e.g., voltage data, current data, power data, etc.) on these internal components during operation of power supply circuitry 12. Measurement circuitry 18 (e.g., one or more of these sensors) may be coupled to electronic component 10 to gather sensor data (e.g., voltage data, current data, power data, etc.) on electronic component 10 (e.g., elements therein) during operation of electronic component 10. Some electronic components 10 may provide pins, or generally terminals, that provide internal measurement data (e.g., voltage data, current data, power data, etc.) and/or other information (e.g., control signals, data signals, etc.) to measurement circuitry 18 and/or to control logic circuitry 16 for use in controlling current source stage(s) 14 and/or other components in power supply circuitry 12.

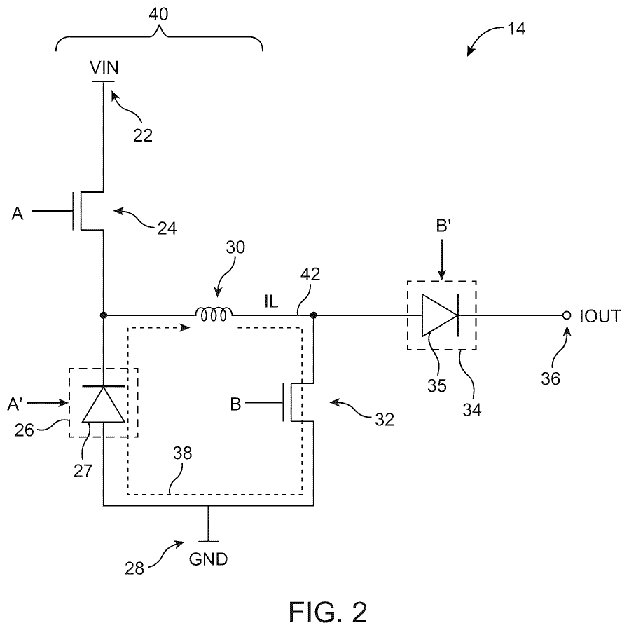

Some illustrative configurations of current source stage(s) 14, control logic circuitry 16, and measurement circuitry 18 are further detailed in connection with FIGS. 2-7.

In some illustrative configurations described herein as an example, electronic components 10 and power supply circuitry 12 may be included in a network device 20. Network device 20 may include or be a switch (e.g., a single-layer (Layer 2) switch or a multi-layer (Layer 2 and Layer 3) switch), a router, a gateway, a bridge, a hub, a repeater, a firewall, a wireless access point, a network management device that manages the operation of one or more other network devices, a device serving other networking functions, a device that includes a combination of these functions, and/or other types of network devices. Network device 20 may be or form part of a modular network device system (e.g., a modular switch system) or may be a fixed-configuration network device (e.g., a fixed-configuration switch).

In particular, network device 20 may include control plane processing circuitry, memory circuitry, data plane processing circuitry (e.g., one or more packet processors), and interface circuitry (e.g., forming input-output interfaces such as network interfaces, forming internal interfaces, etc.), among other components. Control plane processing circuitry and data plane processing circuitry may each include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors. The memory circuitry may include non-volatile memory (e.g., flash memory, electrically-programmable read-only memory, a solid-state drive, hard disk drive storage, etc.), volatile memory (e.g., static random-access memory or dynamic random-access memory), removable storage devices (e.g., storage devices removably coupled to network device 20), and/or other types of memory circuitry. Any of these components of network device 20 may be electronic components 10 coupled to and powered by power supply circuitry 12.

As one illustrative example, electronic components 10 powered by power supply circuitry 12 may include one or more data plane processors (e.g., programmable logic devices or FPGA devices, ASIC processors, etc., implementing packet processors) forming the data plane processing circuitry of network device 20. It can be particularly challenging to supply current to and/or cutoff current from these data plane processors in a satisfactory manner given their current usage characteristics. As an example, for satisfactory operations, a data plane processor may require minimal current supply at a first time when no network traffic is being processed by the processor, may at a second time shortly thereafter (e.g., 100 ns later) receive a batch of network traffic for processing which requires a sharp increase in current supply, and may at a third time shortly thereafter (e.g., 300 ns later) be done with network traffic processing and go back to requiring minimal current supply. These large swings in current supply requirements in a relatively short amount of time can be challenging to meet for some types of power supply circuitry, particularly those with inductive characteristics along the current supply paths. Other types of electronic components 10 (e.g., other than data plane processing circuitry as described in the example above) may have similarly challenging current supply requirements.

To meet these faster current supply and cutoff requirements (e.g., particularly those requiring large current supply swings), power supply circuitry (e.g., power supply circuitry 12 of FIG. 1) may include one or more current source stages 14. A circuit diagram of an illustrative current source stage 14 is shown in FIG. 2.

In the example of FIG. 2, a current source stage 14 may include an input voltage terminal 22 configured to provide an input voltage VIN (e.g., a supply voltage received by power circuitry 12). Current source stage 14 may include a transistor 24 (sometimes referred to as a control transistor) having a first terminal coupled to voltage terminal 22, having a second terminal coupled to inductor 30 (e.g., an input terminal of inductor 30), and having a third terminal (e.g., a gate or control terminal) configured to receive control signal A. When control signal A is asserted, transistor 24 may be activated to connect voltage terminal 22 to inductor 30 (e.g., thereby providing inductor 30 with voltage VIN). When control signal A is de-asserted, transistor 24 may be deactivated to disconnect voltage terminal 22 from inductor 30. Based on voltage VIN being provided to inductor 30, inductor 30 may produce (e.g., output) a current IL on path 42. The value (e.g., magnitude) of current IL may be dependent upon the frequency at which transistor 24 is activated (e.g., the pulse-width modulation or duty cycle(s) of control signal A)

Current source stage 14 may include a diode 27 having a first terminal (e.g., an anode terminal) coupled to ground voltage terminal 28 (e.g., a common ground such as a common ground plane) and having a second terminal (e.g., a cathode terminal) coupled to the input terminal of inductor 30 (e.g., coupled to the common terminal between transistor 24 and inductor 30).

In illustrative configurations sometimes described herein as an example, diode 27 may be included as part of an active or synchronous rectifier 26 (sometimes referred to herein as a synchronous diode 26) implemented using a transistor, whose body diode forms diode 27. In this example, the transistor of rectifier 26 may have a first terminal coupled to ground terminal 28 (e.g., the common ground), a second terminal coupled to the input terminal of inductor 30 (e.g., coupled to the common terminal between transistor 24 and inductor 30), and a third terminal (e.g., a gate or control terminal) that receives a control signal A′, exhibiting asserted and de-asserted states that are coordinated with (e.g., that are synchronous with, have the same periodicity as, etc.) de-asserted and asserted states of control signal A received by transistor 24. In other words, when an asserted control signal A activates transistor 24, a de-asserted control signal A′ may be provided to deactivate the transistor of rectifier 26; and when a de-asserted control signal A deactivates transistor 24, an asserted control signal A′ may be provided to activate the transistor of rectifier 26. There may be deadtime (during which both transistors are deactivated) between the activation of either transistor to ensure that both transistors are not activated simultaneously (e.g., are never activated at the same time). If desired, rectifier 26 may be a diode rectifier (e.g., diode 27 may be a Schottky diode), instead of an active rectifier containing a transistor.

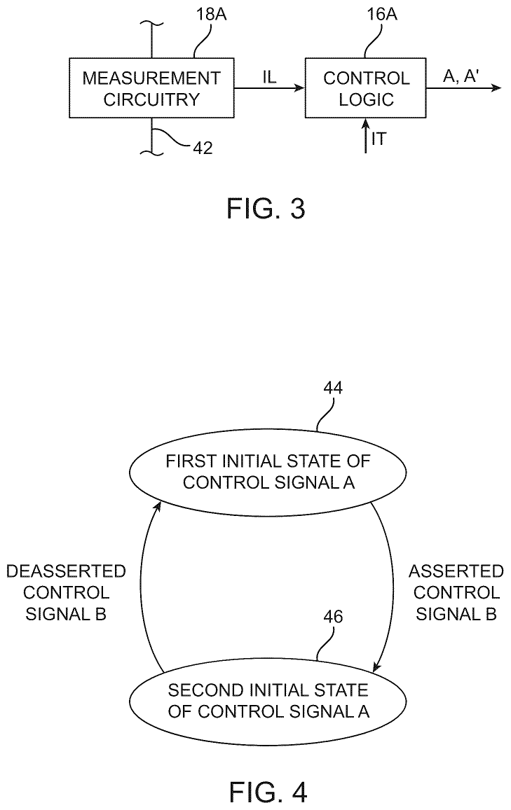

Control signal A received at the control terminal of transistor 24 may be provided by control logic circuitry (e.g., control logic circuitry 16 in FIG. 1). FIG. 3 is a diagram of an illustrative portion of control logic circuitry 16 in FIG. 1, shown as control logic (circuitry) 16A in FIG. 3 (sometimes referred to as first control logic 16A or first control logic circuit 16A), configured to provide control signal A. Control logic 16A may be implemented using one or more components of control logic circuitry 16 as described in connection with FIG. 1. As shown in FIG. 3, control logic 16A may obtain (magnitude) values of, or other information indicative of, current IL output by inductor 30 (FIG. 2). Based on the corresponding value of current IL, control logic 16A may output a control signal A (e.g., with appropriate durations of asserted and de-asserted states) that regulates the inductor output current IL to exhibit a target current value IT (e.g., a fixed or adjustable target value received and/or stored by control logic 16A).

As examples, when the received indication (e.g., value) of current IL indicates a value that is less than the target current value IT, the duty cycle of control signal A may be increased (e.g., control logic 16A may output a control signal A that increases the duration of the asserted state and decreases the duration of the de-asserted state). When the received indication (e.g., value) of current IL indicates a value that is greater than the target current value IT, the duty cycle of control signal A may be decreased (e.g., control logic 16A may output a control signal A that decreases the duration of the asserted state and increases the duration of the de-asserted state). In other words, control logic 16A may perform pulse-width modulation for control signal A to regulate current IL to exhibit the target current value IT.

In the example of FIG. 3, a portion of measurement circuitry 18 in FIG. 1, shown as measurement circuitry 18A in FIG. 3, may be coupled to and/or along path 42 (FIG. 2) to obtain measurement values of current IL. For example, current sensor(s) or other types of sensors may be used to directly obtain the sensor-measured values of current IL or indirectly derive the values of current IL based on other obtained sensor measurement data. The sensor data may be processed (e.g., filtered, converted from analog signals to digital data, etc.) before being provided to control logic 16A or may be directly provided to control logic 16A as the indications (e.g., the values) of current IL. If desired, current IL may be measured or sensed in other manners, such as current mirror designs involving transistors 24 and 26, and/or control logic 16A may obtain the value of current IL in other manners to provide control signal A with the appropriate (asserted or de-asserted) state, e.g., with the desired pulse-width modulation. Control logic 16A may also generate control signal A′ for the transistor of synchronous diode 26 in FIG. 2, e.g., based on control signal A (and consequently based on the values of current IL) to exhibit the synchronous complementary (asserted and de-asserted) states as described in connection with FIG. 2.

When controlled in the manner described above in connection with FIG. 3, the output current of inductor 30 may be regulated to provide output current IL at the target current value IT (e.g., which may be the desired output current value from this current source stage 14). Accordingly, configured in the manner described in connection with FIG. 2 and controlled in the manner described in connection with FIG. 3, input voltage terminal 22, transistor 24, rectifier 26, and inductor 30 may form a current source 40, for stage 14, that outputs current IL regulated to be at the target current value IT.

Referring back to FIG. 2, current source stage 14 may include a transistor 32 (sometimes referred to as a recirculation or current recirculation transistor) having a first terminal coupled to ground voltage terminal 28 (e.g., the common ground such as the common ground plane), having a second terminal coupled to inductor 30 (e.g., an output terminal of inductor 30, an output terminal of current source 40, path 42, etc.), and having a third terminal (e.g., a gate or control terminal) configured to receive control signal B. When control signal B is asserted, transistor 32 may be activated to connect the output terminal of inductor 30 (e.g., the output terminal of current source 40) to the common ground, thereby enable recirculation of current IL through the common ground. In particular, when transistor 32 is activated, output current IL of inductor 30 may be conveyed from the output terminal of inductor 30, along a current recirculation path 38 (e.g., that passes through and includes transistor 32, the common ground, and synchronous diode 26), and back to the input terminal of inductor 30. In other words, current recirculation path 38 couples a first terminal of current source 40 (e.g., the output terminal of inductor 30) to a second terminal of current source 40 (e.g., the input terminal of inductor 30). When control signal B is de-asserted, transistor 32 may be deactivated to disconnect the output terminal of inductor 30 from the common ground.

Current source stage 14 may include a diode 35 having a first terminal (e.g., an anode terminal) coupled to inductor 30 (e.g., the output terminal of inductor 30, the output terminal of current source 40, path 42, etc.) and having a second terminal (e.g., a cathode terminal) coupled to an output terminal 36 of current source stage 14 (e.g., an output terminal of power supply circuitry 12 containing stage 14). Output terminal 36 may be coupled to an electronic component 10 (FIG. 1) to which current source stage 14 supplies current IOUT.

In illustrative configurations sometimes described herein as an example, diode 35 may be included as part of an active or synchronous rectifier 34 (sometimes referred to herein as a synchronous diode 34) implemented using a transistor, whose body diode forms diode 35. In this example, the transistor of rectifier 34 may have a first terminal coupled to inductor 30 (e.g., the output terminal of inductor 30, the output terminal of current source 40, path 42, etc.), a second terminal coupled to output terminal 36 of current source stage 14 (e.g., an output terminal of power supply circuitry 12 containing stage 14), and a third terminal (e.g., a gate or control terminal) that receives a control signal B′, exhibiting asserted and de-asserted states that are coordinated with (e.g., that are synchronous with, have a same periodicity as, etc.) de-asserted and asserted states of control signal B received by transistor 32. In other words, when an asserted control signal B activates transistor 32, a de-asserted control signal B′ may be provided to deactivate the transistor of rectifier 34; and when a de-asserted control signal B deactivates transistor 32, an asserted control signal B′ may be provided to activate the transistor of rectifier 34. There may be deadtime (during which both transistors are deactivated) between the activation of either transistor to ensure that both transistors are not activated simultaneously (e.g., are never activated at the same time). If desired, rectifier 34 may be a diode rectifier (e.g., diode 35 may be a Schottky diode), instead of an active rectifier containing a transistor.

The inclusion of transistor 32 and synchronous diode 34 provides current source stage 14 with two modes of operation: a first mode of operation in which current IL provided by inductor 30 or current source 40 (e.g., maintained or regulated to be at the target current value IT) is supplied as output current IOUT at output terminal 36 through rectifier 34, and a second mode of operation in which current IL provided by inductor 30 or current source 40 (e.g., maintained or regulated to be at the target current value IT) is steered onto current recirculation path 38 and is recirculated back to the input terminal of inductor 30.

In particular, when an electronic component 10 coupled to current source stage 14 should be supplied with current (e.g., current IL), the transistor of synchronous diode 34 may be activated (e.g., with an asserted control signal B′) and transistor 32 may be deactivated (e.g., with a de-asserted control signal B) to operate current source stage 14 in the first mode of operation. When the electronic component 10 coupled to current source stage 14 should be cut off from current (e.g., current IL), the transistor of synchronous diode 34 may be deactivated (e.g., with a de-asserted control signal B′) and transistor 32 may be activated (e.g., with an asserted control signal B) to operate current source stage 14 in the second mode of operation.

Accordingly, the switching between the first and second modes of operation (e.g., from a state in which no current is supplied to component 10 in the second mode to a state in which current IL is supplied to component 10 as current IOUT in the first mode, and from the state in which current IL is supplied to component 10 as current IOUT in the first mode to the state in which no current is supplied to component 10) may involve the activation and deactivation of transistors (e.g., transistor 32, the transistor of synchronous diode 34, etc.), which can be much faster than the involvement of pumping and braking inductive elements (e.g., in a conventional buck converter). While current source stage 14 includes an inductor 30, inductor 30 is continuously regulated (in both the first and second modes of operation) to produce output current IL maintained at a target current value IT, and as such, serves as a current source (without introducing time-dependent inductive effects). As such, at least in part by being configured in this manner, current source stage 14 (and power supply circuitry 12 including stage(s) 14) may quicken current supply and cutoff to component(s) 10.

Power consumption between the first and second modes of operation may be significantly different (e.g., higher in the first mode than in the second mode) because a load (e.g., of component 10) is being actively powered (e.g., actively consumes power) in the first mode, while internal losses along recirculation path 38 cause the power consumption in the second mode. To improve the regulation of current IL when switching between the first and second operating modes (e.g., to prevent significant current sag when switching from the second mode in which current IL is recirculated to the first mode in which current IL is being supplied to component 10), control logic 16A (FIG. 3) may preemptively use predetermined starting states (e.g., initial duty cycles) for control signal A when switching between first and second operating modes.

In particular, FIG. 4 shows a state diagram based on which control logic 16A (FIG. 3) may provide control signal A (for transistor 24 in FIG. 2) in response to changing operating modes of current source stage 14. In particular, based on control signal B (for transistor 32 in FIG. 2) being de-asserted (e.g., based on a falling edge of control signal B) and/or based on other signal(s) indicative of a switch from the second mode of operation to the first mode of operation, control logic 16A may provide (e.g., output) control signal A with a first initial state 44 (e.g., with a first pre-determined duty cycle) suitable as a starting point for regulating current IL when current IL is used to supply current to the coupled load (e.g., of component 10). Control logic 16A may subsequently perform the pulse-width modulation operations described in connection with FIG. 3 (e.g., based on the monitoring or measuring of the actual current IL) to dynamically adjust (e.g., fine-tune) the state of control signal A (e.g., by increasing and/or decreasing the duty cycle of control signal A from the first pre-determined duty cycle).

Similarly, based on control signal B being asserted (e.g., based on a rising edge of control signal B) and/or based on other signal(s) indicative of a switch from the first mode of operation to the second mode of operation, control logic 16A may provide (e.g., output) control signal A with a second initial state 46 (e.g., with a second pre-determined duty cycle less than the first pre-determined duty cycle) suitable as a starting point for regulating current IL when current IL is recirculated. Control logic 16A may subsequently perform the pulse-width modulation operations described in connection with FIG. 3 (e.g., based on the monitoring or measuring of the actual current IL) to dynamically adjust (e.g., fine-tune) the state of control signal A (e.g., by increasing and/or decreasing the duty cycle of control signal A from the second pre-determined duty cycle).

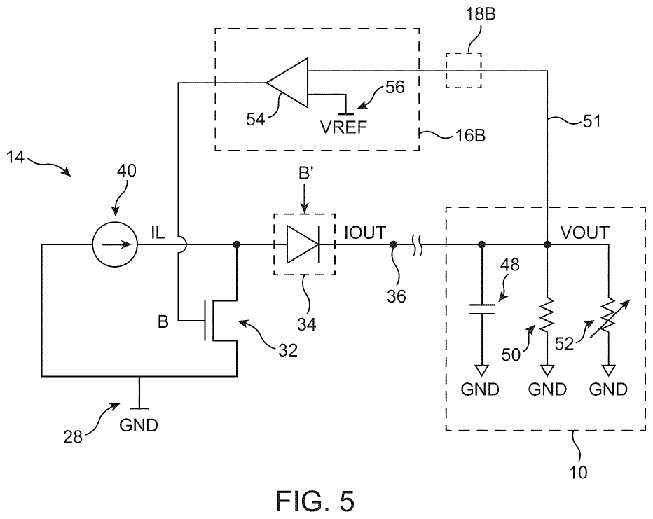

Control signal B received at the control terminal of transistor 32 may be provided by control logic circuitry (e.g., control logic circuitry 16 in FIG. 1). FIG. 5 is a diagram of power supply circuitry 12 containing an illustrative portion of control logic circuitry 16 in FIG. 1, shown as control logic (circuitry) 16B (sometimes referred to as second control logic 16B or second control logic circuit 16B) in FIG. 5, configured to provide control signal B. Control logic 16B may be implemented using one or more components of control logic circuitry 16 as described in connection with FIG. 1. Current source stage 14 of FIG. 5 may be implemented in the same manner as current source stage 14 shown in FIG. 2 and described in connection with FIGS. 2-4. Components of current source 40 as shown and described in connection with FIG. 2 are shown simply as current source 40 in FIG. 5 in order to not unnecessarily obscure the embodiments of FIG. 5.

As shown in FIG. 5, control logic 16B may be configured to provide control signal B based on input(s) received from electronic component 10 coupled to current source stage 14. Current source stage 14 of power supply circuitry 12 may be coupled to component 10 via a current supply path supplying current IOUT, which also serves as a voltage supply path causing (e.g., applying) a voltage VOUT at component 10. Component 10 (e.g., one or more processors of data plane processing circuitry in a network device) may include numerous sub-components, simplified in FIG. 5 to be collectively represented by capacitor 48, resistor 50 representing fixed load(s) acting as a fixed current sink of the supplied current, and resistor 52 representing variable load(s) acting as a variable sink of the supplied current. As examples, capacitor 48 may represent and include bypass capacitors of component 10, resistor 50 may represent and include a clock tree of component 10 and leakage loads of component 10, and resistor 52 may represent and include dynamic processing resources of component 10.

In some illustrative configurations sometimes described herein as an example, the inputs received by control logic 16B to control transistor 32 may be voltage inputs such as (magnitude) values of, or another indications of, voltage VOUT over time on the current supply path coupling current source stage 14 to component 10 (on which current IOUT is supplied). However, this is merely illustrative. If desired, other types of inputs such as other voltage inputs based on voltage values from other paths and/or terminals of component 10, current information (e.g., data signals conveying the current information) indicative of currents along paths of component 10, etc., may be received by control logic 16B (instead of or in addition to the values or indications of voltage VOUT).

If desired, a portion of measurement circuitry 18 in FIG. 1, shown as measurement circuitry 18B in FIG. 5, may be coupled to component 10 (e.g., disposed on path 51 in FIG. 5) to obtain measurement values of voltage VOUT (and/or to obtain other voltage and/or current measurements within component 10). For example, voltage sensor(s) and/or other types of sensors may be used to directly obtain the sensor-measured values of voltage VOUT or indirectly derive the values of voltage VOUT based on other obtained sensor measurement data. Similarly, these sensors may be used to directly obtain or indirectly derive the values of other voltages or currents within component 10. The sensor data may be processed (e.g., filtered, converted from analog signals to digital data, etc.) before being provided to control logic 16B or may be directly provided to control logic 16B as inputs. If desired, voltage VOUT, and other voltages and currents in component 10, may be measured or sensed in other manners and/or control logic 16B may obtain the values of these voltage and currents in other manners to provide control signal B with the appropriate (asserted or de-asserted) state.

In the example of FIG. 5, control logic 16B may include a voltage comparator 54. Comparator 54 may have a first input terminal (e.g., a non-inverting terminal) coupled to component 10 along path 51 to receive values of voltage VOUT and may have a second input terminal (e.g., an inverting terminal) coupled to a reference voltage terminal 56 providing reference voltage VREF. Comparator 54 may have an output terminal coupled to the gate terminal of transistor 32 and configured to provide control signal B to the gate terminal of transistor 32.

The provided control signal B may be de-asserted (i.e., in a de-asserted state) when (the value of) voltage VOUT is less than (the value of) voltage VREF, thereby controlling current source stage 14 to operate in the first mode of operation during which current IL is supplied as current IOUT to component 10. When the supplied current IOUT is greater than the current sunk by component 10 (e.g., greater than the currents sunk by the fixed and variable loads represented by resistors 50 and 52), the supply current provided to capacitor 48 causes voltage VOUT to increase. The control signal B provided by comparator 54 may be asserted (i.e., in an asserted state) when (the value of) voltage VOUT is greater than (the value of) voltage VREF, thereby controlling current source stage 14 to operate in the second mode of operation during which current IL is recirculated within stage 14 (e.g., via path 38 in FIG. 2). When the current IL is cut off from component 10 (e.g., is recirculated within stage 14), current continues to be sunk by component 10 (e.g., at least by fixed loads represented by resistor 50, if not also by variable loads represented by resistor 52), and no supply current is provided to capacitor 48, voltage VOUT decreases, causing comparator 54 to de-assert control signal B again. Operation may continue in a similar manner, as the values of voltage VOUT swing above and below the value of voltage VREF and comparator 54 asserts and de-asserts control signal B.

Control logic 16B may also generate control signal B′ for the transistor of synchronous diode 34 as described in connection with FIG. 2, e.g., based on control signal B (and consequently based on the values of voltage VOUT) to exhibit the synchronous complementary (asserted and de-asserted) states as described in connection with FIG. 2.

The implementation of control logic 16B based on comparator 54, as described in connection with FIG. 5, is merely illustrative. Control logic 16B may include other components (e.g., components as described in connection with control logic circuitry 16 in FIG. 1) in addition to or instead of comparator 54. In general, control logic 16B may provide control signal B (and control signal B′) based inputs such as sensor measurement data, communicated data signals, control signals, etc., that are indicative of the desired operating requirement (e.g., current supply requirement) for component 10 and/or the desired operating mode for (e.g., the desired current to be supplied from) current source stage 14. These types of inputs may be provided by component 10, by a controller for component 10 such as control plane processing circuitry of network device 20, and/or by other components external to current source stage 14.

In some scenarios (e.g., in complex systems), there may be numerous inputs received by control logic 16B for generating a control signal B, especially in configurations in which power supply circuitry 12 includes multiple current source stages 14 (e.g., collectively powering the same component 10) and control logic 16B may provide corresponding (interdependent) control signals B to the corresponding current source stages 14. Regardless of the control scheme implemented using control logic 16B, each current source stage 14 when implemented in the manner described in connection with FIGS. 2-5 may still advantageously provide improved (e.g., faster) current supply and cutoff behavior for component 10.

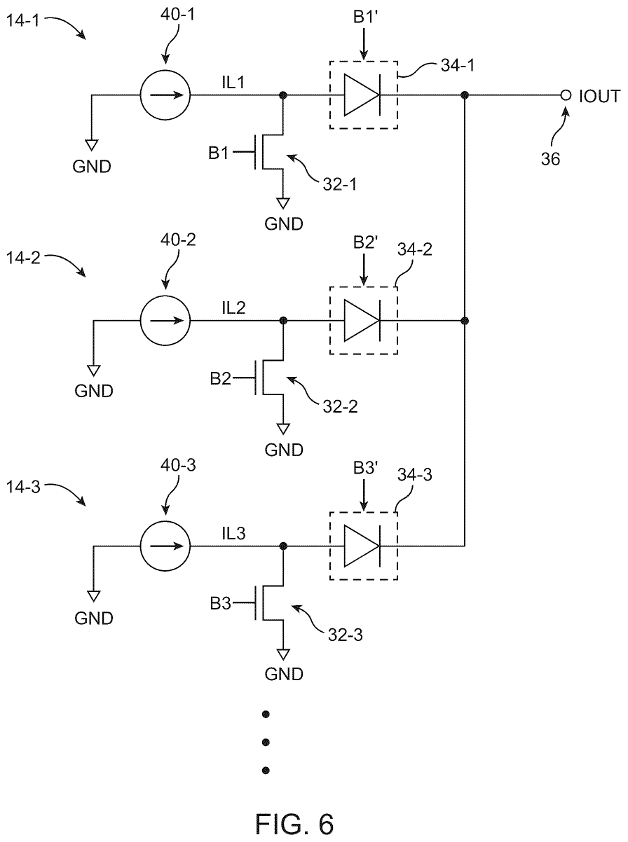

FIG. 6 is a diagram of an illustrative set of multiple current source stages 14 operating collectively (e.g., in power supply circuitry 12) to supply current IOUT to a component 10 (e.g., coupled to output terminal 36 of the plurality of current source stages 14). Power supply circuitry 12 may include three or more current source stages 14, or generally any desired number of current source stages 14 (e.g., one current source stage 14 as shown in FIG. 2, two current source stages 14, etc.). As shown in the example of FIG. 6, power supply circuitry 12 may include at least current source stages 14-1, 14-2, and 14-3 (e.g., multiple instances of current source stage 14 as described in connection with FIGS. 2-5).

Current source 40-1 of stage 14-1 (e.g., including an input voltage terminal, a transistor, a rectifier such as a synchronous diode, and an inductor implemented in a manner analogous to the manner in which terminal 22, transistor 24, synchronous diode 26 and inductor 30 in FIG. 2 are implemented) may be configured to provide current IL1. Depending on the activated or deactivated state of recirculation transistor 32-1 (and the complementary deactivated or activated state of synchronous diode 34-1, or more specifically, of the transistor implementing synchronous diode 34-1), stage 14-1 may operate in the first or second mode of operation (e.g., as described for stage 14 in connection with FIG. 2). In particular, stage 14-1 may provide current IL1 via synchronous diode 34-1 to output terminal 36 in the first mode of operation when transistor 32-1 is deactivated (and the transistor of synchronous diode 34-1 is activated), and may recirculate current IL1 via transistor 32-1 (via the circulation path analogous to path 38 in FIG. 2) in the second mode of operation when transistor 32-1 is activated (and the transistor of synchronous diode 34-1 is deactivated).

Current source 40-2 of stage 14-2 (e.g., including an input voltage terminal, a transistor, a rectifier such as a synchronous diode, and an inductor implemented in a manner analogous to the manner in which terminal 22, transistor 24, synchronous diode 26 and inductor 30 in FIG. 2 are implemented) may be configured to provide current IL2. Depending on the activated or deactivated state of recirculation transistor 32-2 (and the complementary deactivated or activated state of synchronous diode 34-2, or more specifically, of the transistor implementing synchronous diode 34-2), stage 14-2 may operate in the first or second mode of operation (e.g., as described for stage 14 in connection with FIG. 2). In particular, stage 14-2 may provide current IL2 via synchronous diode 34-2 to output terminal 36 in the first mode of operation when transistor 32-2 is deactivated (and the transistor of synchronous diode 34-2 is activated), and may recirculate current IL2 via transistor 32-2 (via the circulation path analogous to path 38 in FIG. 2) in the second mode of operation when transistor 32-2 is activated (and the transistor of synchronous diode 34-2 is deactivated).

Current source 40-3 of stage 14-3 (e.g., including an input voltage terminal, a transistor, a rectifier such as a synchronous diode, and an inductor implemented in a manner analogous to the manner in which terminal 22, transistor 24, synchronous diode 26 and inductor 30 in FIG. 2 are implemented) may be configured to provide current IL3. Depending on the activated or deactivated state of recirculation transistor 32-3 (and the complementary deactivated or activated state of synchronous diode 34-3, or more specifically, of the transistor implementing synchronous diode 34-3), stage 14-3 may operate in the first or second mode of operation (e.g., as described for stage 14 in connection with FIG. 2). In particular, stage 14-3 may provide current IL3 via synchronous diode 34-3 to output terminal 36 in the first mode of operation when transistor 32-3 is deactivated (and the transistor of synchronous diode 34-3 is activated), and may recirculate current IL3 via transistor 32-3 (via the circulation path analogous to path 38 in FIG. 2) in the second mode of operation when transistor 32-3 is activated (and the transistor of synchronous diode 34-3 is deactivated).

Accordingly, depending on the operating modes of each of the current source stages 14 (e.g., stages 14-1, 14-2, and 14-3) of power supply circuitry 12, different output current IOUT may be provided at terminal 36 coupled to component 10. As an example, when stages 14-1, 14-2, and 14-3 each operate in the first mode of operation to supply current to component 10, the output current IOUT may include (e.g., be a summation of) current IL1, current IL2, and current IL3. As another example, when stage 14-3 operates in the second mode of operation to recirculate current and stages 14-1 and 14-2 each operate in the first mode of operation to supply current to component 10, the output current IOUT may include (e.g., be a summation of) current IL1 and current IL2. As yet another example, when stages 14-1, 14-2, and 14-3 each operate in the second mode of operation to recirculate current, the output current IOUT may be zero and component 10 may be cut off from current supplied by current sources 40-1, 40-2, and 40-3.

Current IL provided by the current source 40 of each stage 14 may be the same as current IL provided by the current source(s) 40 of some, none, or all of other stage(s) 14 and/or different from current IL provided by the current source(s) 40 of some, none, or all of other stage(s) 14. As examples, (the magnitude of) current IL1, current IL2, and current IL3 may be the same, (the magnitude of) current IL1 may be the same as (the magnitude of) current IL2 but different than (the magnitude of) current IL3, or (the magnitude of) current IL1 may be different from (the magnitude of) current IL2 which is different from (the magnitude of) IL3. Control logic circuitry 16 in FIG. 1 (e.g., control logic 16A in FIG. 3) may be configured to regulate the output current level of the current source 40 of each of these current source stages 14 (e.g., by regulating, in a manner analogous to the manner as described in connection with FIG. 3, to achieve the same target current value IT or to achieve different target current values for current sources 40 in different stages 14).

The advantages of improved current supply and cutoff behavior as described in connection with FIG. 2 are preserved in the configuration (of power supply circuitry 12) with multiple current source stage 14. In fact, by providing multiple parallel stages 14 that can operate collectively to supply current to a component 10, large amounts of current can be supplied to and/or with cutoff from component 10 within a relatively short amount of time (e.g., by switching the transistors in the multiple stages 14).

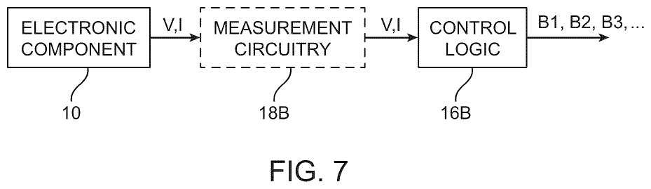

Control logic circuitry 16 (e.g., control logic circuitry 16B) may provide control signals to each of the multiple current source stages 14 to appropriately operate them (e.g., switch current source stages 14 between first and second modes of operation) to provide the desired current to component 10. FIG. 7 is a diagram of illustrative control logic 16B (e.g., part of control logic circuitry 16 in FIG. 1) used to provide control signals B (e.g., control signals B1, B2, and B3 in FIG. 6) to respective recirculation transistors 32 of current source stages 14 (e.g., transistors 32-1, 32-2, and 32-3 in FIG. 6). Control logic 16B may be implemented using one or more components of control logic circuitry 16 as described in connection with FIG. 1. Control logic 16B may also generate control signals B′ (e.g., control signals B1′, B2′, and B3′ in FIG. 6) for respective transistors of synchronous diodes 34 of current source stages 14 (e.g., diodes 34-1, 34-2, and 34-3 in FIG. 6), e.g., based on the corresponding control signals B to exhibit the synchronous complementary (asserted and deasserted) states as described in connection with FIG. 2.

Control logic 16B may receive various input(s) containing information (e.g., operational data) indicative of the operational state of electronic component 10. These inputs may include voltage values provided by electronic component 10, may include internal voltage and/or current information communicated from electronic component 10 (or a controller of electronic component 10) to control logic 16B via corresponding data signals containing the information, and/or may include voltage measurement data, current measurement data, power measurement data, and/or other sensor data measured by sensors of measurement circuitry 18B (e.g., a portion measurement circuitry 18 in FIG. 1).

Control logic 16B may generate and provide control signals B (e.g., control signals B1, B2, and B3 in FIG. 6) to corresponding current source stages 14 (e.g., stages 14-1, 14-2, and 14-3 in FIG. 6) based on the received inputs. In other words, these received inputs may be indicative of the current requirements of component 10, and control logic 16B may configure power supply circuitry 12 based on the indicated (desired) current requirements of component 10. The configuring of power supply circuitry 12 by control logic 16B may include operating one or more current source stages 14 in the first mode of operation to pass current source current IL to common output terminal 36 of power supply circuitry 12, operating one or more current source stages 14 in the first mode of operation to recirculate current source current IL, controlling control logic 16A to adjust the target voltage IT for one or more current sources 40 of stages 14 to provide the desired output current IL, etc.

As one example, control logic 16B may receive indications (e.g., values) of voltage VOUT on a current supply path (e.g., as shown in the example of FIG. 5) on which current IOUT is supplied to component 10. Control logic 16B may provide control signals B for recirculation transistors 32 in different stages 14 (and corresponding complementary control signals B′ for synchronous diodes 34) based on the (magnitude) values of voltage VOUT.

As another example, control logic 16B may receive indications (e.g., values) of desired current to be supplied (e.g., as data signal(s) communicated from component 10 to power supply circuitry 12). Control logic 16B may provide control signals B for recirculation transistors 32 in different stages 14 (and corresponding complementary control signals B′ for synchronous diodes 34) based on the current communicated and indicated by component 10.

The foregoing is merely illustrative and various modifications can be made to the described embodiments. The foregoing embodiments may be implemented individually or in any combination.

What is claimed is:

1. Power supply circuitry comprising:
a current source configured to provide a current;
an output terminal;
a rectifier coupled between the current source and the output terminal and configured to provide the current to the output terminal during a first mode of operation; and
a current recirculation transistor coupled to the current source and configured to recirculate the current provided by the current source during a second mode of operation.

2. The power supply circuitry defined in claim 1, wherein the current source has a first terminal at which the current is provided and has a second terminal, wherein a current recirculation path couples the first terminal to the second terminal, and wherein the current recirculation transistor is disposed on the current recirculation path and is configured to recirculate the current via the current recirculation path.

3. The power supply circuitry defined in claim 1, wherein the rectifier is a synchronous rectifier containing an additional transistor coupled between the current source and the output terminal.

4. The power supply circuitry defined in claim 3, wherein the current recirculation transistor is deactivated during the first mode of operation and is activated during the second mode of operation and wherein the additional transistor is activated during the first mode of operation and is deactivated during the second mode of operation.

5. The power supply circuitry defined in claim 4, wherein the current recirculation transistor and the additional transistor are not activated simultaneously.

6. The power supply circuitry defined in claim 3 further comprising:
control logic circuitry coupled to the current recirculation transistor and to the additional transistor and configured to:
receive an input from an electronic component to which the current is supplied via the output terminal during the first mode of operation;
provide a first control signal to the current recirculation transistor based on the input; and
provide a second control signal to the additional transistor based on the input.

7. The power supply circuitry defined in claim 1, wherein the current source comprises:
an input voltage terminal;
an inductor configured to provide the current;
a control transistor coupled between the input voltage terminal and the inductor; and
an additional rectifier coupled to a common terminal between the inductor and the control transistor.

8. The power supply circuitry defined in claim 7, wherein the additional rectifier is a synchronous rectifier containing an additional transistor coupled to the common terminal between the inductor and the control transistor, the power supply circuitry further comprising:
control logic circuitry coupled to the control transistor and to the additional transistor and configured to:
obtain values of the inductor-provided current;
provide a first control signal to the control transistor based on the values; and
provide a second control signal to the additional transistor based on the values.

9. The power supply circuitry defined in claim 8, wherein the control logic circuitry is configured to provide the first control signal with a first initial duty cycle when switching to the first mode of operation and is configured to provide the first control signal with a second initial duty cycle, less than the first initial duty cycle, when switching to the second mode of operation.

10. The power supply circuitry defined in claim 7 further comprising:
a common ground, wherein the additional rectifier is coupled between the common ground and the common terminal between the inductor and the control transistor and wherein the current recirculation transistor is coupled between the inductor and the common ground.

11. The power supply circuitry defined in claim 10, wherein the current recirculation path passes through the current recirculation transistor, the common ground, and the additional rectifier.

12. The power supply circuitry defined in claim 1, wherein the current source, the rectifier, the current recirculation transistor at least partly forms a first current source stage, the power supply circuitry further comprising:
one or more additional current source stages each coupled to the output terminal and each including a corresponding current source, a corresponding diode, and a corresponding current recirculation transistor.

13. The power supply circuitry defined in claim 12 further comprising:
control logic circuitry coupled to the first current source stage and the one or more additional current source stages and configured to:
receive an input indicative of current consumption by an electronic component; and
provide, based on the received input, one or more control signals to each of the first current source stage and the one or more additional current source stages to operate each of the first current source stage and the one or more additional current source stages in the first mode of operation or the second mode of operation.

14. A current source stage comprising:
an input voltage terminal;
an inductor having an input terminal and an output terminal;
a first transistor coupled between the input voltage terminal and the input terminal of the inductor;
a common ground;
a first diode coupled between the input terminal of the inductor and the common ground;
a second transistor coupled between the output terminal of the inductor and the common ground; and
a second diode coupled to the output terminal of the inductor.

15. The current source stage defined in claim 14, wherein the first diode is a first synchronous diode formed by a third transistor configured to operate synchronously with the first transistor.

16. The current source stage defined in claim 15, wherein the second diode is a second synchronous diode formed by a fourth transistor configured to operate synchronously with the second transistor.

17. The current source stage defined in claim 16, wherein the first and third transistors are not activated simultaneously and wherein the second and fourth transistors are not activated simultaneously.

18. The current source stage defined in claim 14, wherein the inductor is configured to provide a current at the output terminal for output through the second diode during a first mode of operation and wherein the provided current is recirculated through the second transistor, the common ground, and the first diode during a second mode of operation.

19. A network device comprising:
an electronic component; and
power supply circuitry comprising:
an output terminal coupled to the electronic component; and
a plurality of current source stages, each current source stage including:
a current source that provides a current;
a current recirculation path for the current coupled to the current source;
a current recirculation transistor on the current recirculation path; and
a rectifier coupled between the current source and the output terminal of the power supply circuitry and configured to operate synchronously with the current recirculation transistor.

20. The network device defined in claim 19, wherein the electronic component comprises data plane processing circuitry.
